(19) United States
(12) Patent Application Publication
(10) Pub. No.: US 2009/0317762 A1
(43) Pub. Date: Dec. 24, 2009

(54) IMPLANTS WITH POROUS OUTER LAYER, AND PROCESS FOR THE PRODUCTION THEREOF

(75) Inventors: Herwig Schiefer, Aachen (DE); Martin Bram, Juelich (DE); Hans-Peter Buchkremer, Heinsberg (DE); Detlef Stoever, Niedcrzier (DE); Gerbard Hubert Mattonet, Dueren (DE)

Correspondence Address: JORDAN AND HAMBURG LLP, 122 EAST 42ND STREET, SUITE 4000, NEW YORK, NY, 10168, US

(73) Assignee: FORSCHUNGSZENTRUM JUELICH GMBH, Juelich (DE)

(21) Appl. No.: 12/309,747

(22) PCT Filed: Jul. 6, 2007
(86) PCT No.: PCT/DE2007/001208

§ 371 Date: Jan. 28, 2009

(30) Foreign Application Priority Data
Aug. 2, 2006 (DE) 10 2006 036 039.7

(51) Int. Cl. A61C 8/00; A61C 13/083

(52) U.S. Cl. 433/173; 433/201.1

(57) ABSTRACT

Provided are implants having a porous coating, comprising an implant core made of solid material and a sleeve fitted thereon, wherein the sleeve comprises an outer porous region in addition to an inner non-porous region. The invention further provides a method for joining the solid implant core and a sleeve comprising an outer porous region as well as an inner non-porous region.

The invention relates to implants having a porous outer layer, particularly dental implants, and to a method for the production thereof.

### STATE OF THE ART

An implant shall be understood to be an artificial material that is implanted in the body and, with the exception of a temporary implant, is generally intended to remain there permanently or at least for an extended period.

A differentiation is frequently made according to plastic, medical, and functional implants. Plastic implants are used in plastic surgery, for example as replacements for destroyed body parts, or to enlarge existing body parts. Functional implants are generally considered to be those which are used, among other things, for monitoring animals, where, for example, special chips are implanted under the skin. The role of medical implants is to support or replace body functions. Depending on the function, they are also referred to as implanted prostheses. In dental medicine, implants are used as fastening anchors for artificial teeth, bridges, or dentures.

Dental implants are foreign materials inserted in the jaw bone. Since they can also be used as carriers of tooth replacements, they can also be referred to as artificial dental roots. In general, dental implants are screwed, or simply inserted, into the jaw bone using a screw thread. Typically, they bond with the surrounding bone within 3 to 6 months to form a strong, extremely durable carrier unit. In this process, the micro-morphological surface configuration of the implant plays a key role. Those areas which later are intended to have contact with the bone or tissue should have an average roughness of 5μ to 100μ.

The macro-morphological configuration (implant form) particularly impacts surgical processability and the form often depends, not only on the attachment situation encountered in the specific case, but also on the bone condition of the patient.

For dental implants, the configuration of the post protruding from the jaw bone influences the quality of dental processability. Dental implants are typically made of titanium or titanium alloys, which have been used successfully, but may also be made of ceramic materials, such as zirconium oxide. Unfortunately, known ceramic implants do not establish a bond with the bone that is equal to titanium. Practical work with this material is not yet sufficient for it to be considered a true alternative to titanium. Thus, in this respect, more time is required.

Today, implants are made almost exclusively of titanium, since bone cells can grow directly on titanium and allergies can be largely ruled out. This is due to the fact that titanium forms a titanium oxide layer, which is particularly tissue-friendly. Outside the bone, polished precious metals or smooth ceramics are used regularly since they are less readily contaminated by bacteria, due to their low surface porosity, and are therefore generally tolerated better.

In recent years, the screw form having a roughened surface has become popular, since a screw is stable per se, directly after surgery. In addition, cylindrical shapes, root shapes, leaf implants, or plate implants are also available. These may be superior to the screw in the case of special bone situations.

The following methods are presently known methods for coating an implant with porous titanium:

From [1], the sinter-fusing of coarse, spherical titanium powder having a diameter between 420 and 500 μm onto a pure titanium core is known as a method for producing a dental implant, in which temperatures are adjusted to as high as 1400° C. During the sinter-fusing of the spherical particles, the resulting overall porosity is determined by the packing of spheres, while the specific pore shape is dependent on the particle geometry. In general, the overall porosity level is less than 40% by volume. Average pore diameters of more than 100 μm are possible only conditionally, since the required coarse powders are very difficult to sinter, except at extremely high sintering temperatures.

Furthermore, as is known from [2], with a titanium specimen, sintering that is supported by microwaves can generate a graduated porosity on the surface, together with a dense core, in a single production operation. In the process, pore sizes of 30 to 100 μm are obtained in the outer region, resulting in a maximum porosity of 27% by volume. [2] furthermore points out the disadvantages of coating methods that have been commonly used in the past. During plasma spraying, the interface geometry between the porous coating and the core often causes stress concentrations that adversely affect fatigue strength. Furthermore, the high temperatures, which occur during coating and are required for a stable connection between the core and coating, impair the microstructure, and therefore likewise disadvantageously reduce fatigue strength.

In the past, plasma spraying of titanium powder onto an implant core has been known as a conventional method for macroporous coating [3]. This also allows for the production of a graduated porosity. The diameter of the macropores reaches 150 μm or somewhat greater. With the help of plasma spraying, overall porosity levels of up to 25% by volume can generally be achieved, with optimized process parameters as high as 35% by volume.

Another alternative for producing orthopedic implants is the provision of porous titanium, which is produced by casting a titanium slurry around a PU foam, drying and thermally removing the foam and the binder from the slurry, followed by subsequent sintering [4].

In addition, a slurry coating is known from the Sulzer company, wherein the pores are produced using a polymer as the space-holder. This coating is known by the name of CSTi coating (CSTi=cancellous structured titanium) [5]. These CSTi coatings are also applied to dental implants and have an average porosity of 57% by volume, with pore sizes between 69 and 662 μm.

Small pores, particularly pores smaller than 100 μm, are generally considered sufficient for porous coatings, which are directly only at interlocking the bone with the outer pores. For implants intended to become embedded in the bone, which is to say, into which the blood vessels are also intended to grow, pore sizes of at least 300 μm are typically required. Thus, for macroscopically thick implants, therefore, pore diameters in the range of several 100 μm are recommended.

Problem and Solution

The object of the invention is to provide an implant having a porous surface, the implant having a defined porosity and being highly mechanically durable. In particular, the object of the invention is to provide a dental implant having these properties.

The object of the invention is achieved by an implant comprising all the characteristics according to the main claim, and by a production method according to the additional independent claim. Advantageous embodiments of the implant and the production thereof are disclosed in the dependent claims relating to these claims, respectively.

Subject Matter of the Invention

It has been found that the mechanical stability of an implant can be considerably improved if the material of the core, after shaping, is not exposed to any thermal stress at high temperatures. Such thermal stress regularly results in undesirable grain growth inside the material and in a change in the microstructure, which can cause degradation of the mechanical properties of the entire implant and, in particular, a reduction of fatigue strength.

The plasma spraying methods commonly employed for applying a porous coating onto a metal core generally resulted in inhomogeneous pore distribution and/or relatively small pores (<150 μm), making bone ingrowth difficult, in addition to the above-mentioned disadvantageous thermal stress at the core. Furthermore, high overall porosity levels of more than 50% by volume cannot ordinarily be achieved with the plasma spraying method.

The method according to the invention for producing an implant provides that a solid implant core and a matching sleeve having a porous coating are produced separately from each other, and are combined only thereafter, by use of a suitable joining technique, so as to form the implant.

A conventional implant core can be used as the solid implant core. Possible implant cores are made of strain-hardened titanium or alloys, such as Ti-6AI-4V or Ti-6AI-7Nb. The implant core is preferably produced by conventional machining of commonly available implant materials.

In a particular embodiment of the method, bores and/or threads used for joining additional components are provided on the solid implant core, in advance.

The sleeve has an outer porous coating in addition to a solid region. The porous coating can be applied to the solid region using conventional coating methods.

In an advantageous embodiment, the porous coating is applied using the so-called space-holder method (DE 196 38 927 und DE 197 26 961). In this process, specific pore sizes can be adjusted in a range from 100 to 2000 μm. Additionally, porosity levels of up to 80% by volume are achieved. Coatings having pore sizes between 100 and 500 μm with a porosity of 60 to 65% by volume have proven to be particularly advantageous.

Optionally, the porous coating can also be machined in the non-sintered state, which is described, for example, in DE 102 24 671. Such a method is advantageous if a certain outside contour of the porous coating, for example a cone for a press fit in the bone, is to be produced prior to sintering. With this method, the surface of the porous coating is specifically structured, without the machining operation degrading the open porosity.

The a sleeve as defined in the present invention can be produced, for example, by cold isostatic pressing of a metal powder/(NH₄)HCO₃ powder mixture onto a solid round stock. The method is suitable for all common implant materials, provided that pressable starting powders are available. The space-holder is removed from the green body, and the entirety is sintered. Near net shape fabrication can be performed after sintering, advantageously however this is performed prior to sintering the green body. In the latter case, the open porosity required for the ingrowth of the bone is advantageously maintained. The round stock is axially drilled out, on at least one side, in order to produce a corresponding sleeve.

Using a specific joining technique, the solid implant core and the sleeve are then joined. For this, two alternatives are proposed as part of the invention, without thereby excluding from the invention further possible methods considered by the person skilled in the art for joining the implant core and sleeve.

In a first advantageous embodiment, the solid core is simply pressed into the sleeve. The outside diameter of the core and the inside diameter of the sleeve are accordingly geometrically matched to each other. During pressing, a planar connection of the sleeve and implant core is obtained, which has sufficient stability for the application.

In a variation of the above embodiment, the solid core is first cooled in liquid nitrogen. The sleeve is heated in air in a circulating air oven to a maximum of 400° C. Due to the differing thermal expansion, the sleeve is widened with respect to the core diameter of the implant core. As a result, the core can be inserted with particular ease at least up to half way into the sleeve. The remainder can be completely driven into the sleeve by mechanically pressing it in. The planar bond between the sleeve and implant core, which is required for sufficient stability, is achieved by way of temperature equalization (shrinking of the sleeve onto the core) and the plastic deformation of the contact surface during the pressing-in operation.

In a further embodiment, the above bond between the sleeve and implant core is further improved in that a screw is inserted on the opposite side, the screw bracing the core and sleeve relative to each other. The projecting implant core having a slit for the screw-in step can be mechanically post-treated and roughened, for example by sand blasting. In this way, notably, the adhesion of cells in this region can be ensured.

Since the solid implant core, which makes a significant contribution to the stability of the implant, is not usually heated to above room temperature when using the bonding technique according to the invention, modification of the microstructure in the solid part of the dental implant, which can result in degradation of the mechanical properties, and particularly the fatigue strength, is advantageously avoided.

Specific Description

Hereafter, the subject matter of the invention will be described in more detail, based on two figures, without thereby limiting the subject matter of the invention.

The production method will be explained in more detail by way of the example of a dental implant. This implant is to be inserted into a bore in the jaw bone. For improved anchoring, so-called press fitting of the implant in the bone may be provided, wherein the diameter of the bore in the bone is selected to be slightly smaller than the implant diameter, and wherein the implant has a slightly conical shape. The porous coating becomes embedded in the bone tissue so as to improve the anchoring of the implant. As a result, lasting anchoring in the bone is achieved.

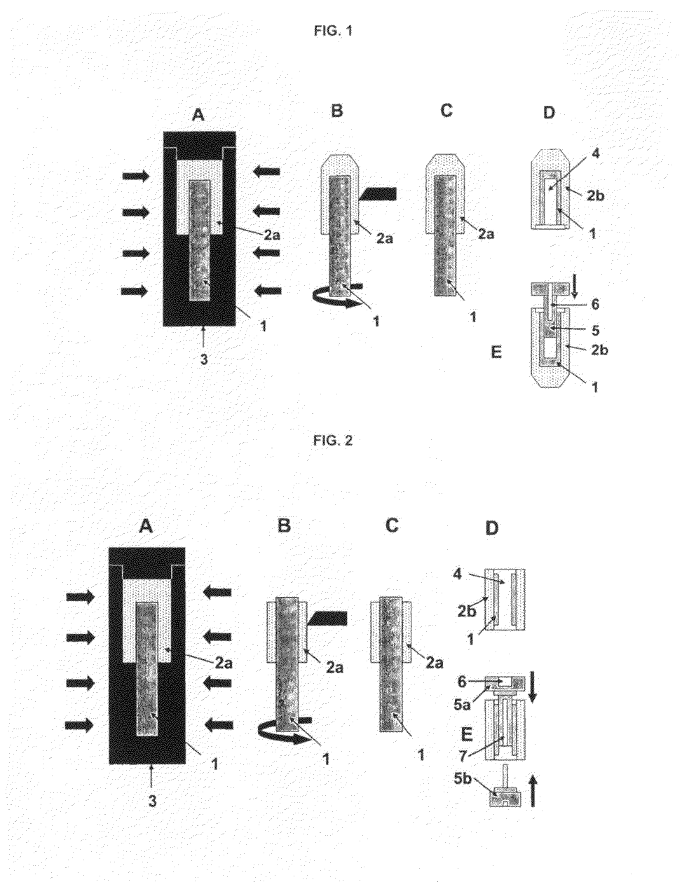

FIGS. 1 and 2 show two embodiments of the method according to the invention for producing a dental implant. They differ notably in terms of different joining techniques for the implant core and sleeve.

In the figures, the following meanings apply:

1 Solid implant core

2a Coating comprising a powder/space-holder mixture

2b Porous coating made therefrom

3 Elastic mold

4 Recess in the sleeve

5, 5a Solid implant core

5b Screw

6 Recess for receiving a part to be joined to the implant

7 Internal thread for receiving the screw 5b

FIG. 1 shows, from left to right, the production of the sleeve and the joining thereof to an implant core. By means of cold isostatic pressing (A), a coating 2a comprising a powder/space-holder mixture is produced on a solid round stock 1 in a mold 3. The coating is not normally applied to the entire surface of the round stock. After pressing, the green body can advantageously be clamped on the protruding part of the round stock and further machined (B). Conical turning of the sleeve in the upper region of the coating is shown here, by way of example. Following the near net shape machining operation, the space-holder is removed and the sintering operation is performed (C).

In (D), the solid round stock is drilled out on one side 4, so as to obtain a terminal sleeve comprising the now outer porous coating (2b) and an inner solid region. In (E), the previously produced solid implant core 5 is driven into the sleeve. To this end, it may be advantageous to cool the implant core in combination with heating the sleeve (joining by shrink-fitting, press fit). According to FIG. 1, the solid implant core 5 comprises an additional recess 6, which is suited for receiving a tooth, for example.

This embodiment is particularly suited for being anchored in the bone using a so-called press fit. For this purpose, the outer geometry of the sleeve is then usually configured to be, at least predominantly, conically.

FIG. 2 shows a further embodiment of the production method according to the invention. The first step of the method for producing the porous coating (A) remains the same as the method described above. During the near net shape machining operation (B), however, the coating is turned to form a cylindrical jacket, so that the solid round stock is exposed on both sides. In (C), the space-holder is removed, and the green body is sintered. In a manner similar to FIG. 1, the solid round stock is subsequently drilled out 4 in (D), but all the way through in this case.

The joining step between the sleeve and implant core is performed in a manner similar to that in the first case, however the solid implant core here comprises a solid implant core having an internal thread 5a and a matching- screw 5b. On one side, the solid implant core has an internal thread 7 for receiving a screw, which is used to brace the solid implant core relative to the sleeve. Again, the solid implant core comprises an additional recess 6, which is suited for receiving a tooth, for example. Optionally, the recesses 6 and 7 can be configured continuously or identically, so that the bracing of the implant core relative to the sleeve and the receiving of the tooth, for example, are achieved by a single recess and/or an internal thread.

Literature cited in the application:

[1] K. Asaoka, N. Kuwayama, O. Okuno, I. Miura, “Mechanical properties and biomechanical compatibility of porous titanium for dental implants”, J. of Biomed. Mat. Res., 19, 699-713 (1985)

M. G. Kutty, S. Bhaduri, S. B. Bhaduri, “Gradient surface porosity in titanium dental implants: relation between processing parameters and microstructure”, J. Mat. Sci.: Mat. in Med., 15, 145-150 (2004)

Y. Z. Yang, J. M. Tian, J. T. Tian, Z. Q. Chen, X. J. Deng, D. H. Zhang, “Preparation of graded porous titanium coatings on titanium implant materials by plasma spraying”, J. Biomed. Mat. Res., 52 (2), 333-337 (2000)

J. P. Li, K. de Groot. “Porous titanium with reticulate structure for orthopedic implant”, Proc. 10th World Conf. on Titanium, 13-18 July 2003, Hamburg, 1-7

B. J. Story, W. R. Wagner, “Zahnimplantate: Schraube oder Zylinder ?” [Dental implants: screw or cylinder?], Sulzer Technical Rev., 1, 38-40 (1998)

1. A method for producing an implant having a solid implant core and a porous coating, comprising the steps of:
a. providing a solid implant core,
b. providing a sleeve having an outer porous coating and an inner solid region,
wherein the sleeve is made by a process comprising the steps of:
applying a metal powder/space-holder powder mixture to a solid round metal stock by cold isostatic pressing, forming the outer porous coating,
machining the resulting non-sintered body to near net shape,
removing the space-holder and sintering the entire body,
at least partially drilling out the round stock, so that an inner, non-porous region remains, and
c. joining the solid implant core and the sleeve having the outer porous coating and the inner solid region to each other.

2. The method according to claim 1, wherein the implant core comprises titanium or a titanium alloy.

3. The method according to claim 1 or 2, wherein (NH₄)HCO₃ is used as the space-holder.

4. The method according to claim 1 or 2, wherein the metal powder has an average particle size of less than 75 mm.

5. The method according to claim 1 or 2, wherein the metal powder is titanium or a titanium alloy.

6. The method of claim 1 or 2, wherein the round metal stock is made of titanium or a titanium alloy.

7. The method of claim 1 wherein the implant is a dental implant.

8. The method of claim 1 or 2, wherein the joining of the solid implant core and the sleeve is performed by pressing the core into the sleeve.

9. The method of claim 1 or 2, wherein the joining of the solid implant core and sleeve comprises the following steps:
a. cooling the implant core
b. heating the sleeve
c. inserting the cooled implant core into the hot sleeve.

10. The method of claim 1 or 2, wherein the joining of the solid implant core and sleeve comprises the following steps:
a. inserting a solid implant core having an internal thread for a screw from one side of the continuous sleeve
b. inserting a screw from the other side of the sleeve and bracing the implant core relative to the sleeve.

11. An implant having a porous coating, comprising a solid implant core made of:
a solid material and a sleeve fitted thereon, wherein the sleeve comprises an outer,
porous region as well as an inner non-porous region.

12. The implant according to claim 11, comprising titanium or a titanium alloy as the solid material of the implant core.

13. The implant according to either of claims 11 or 12, wherein the material for the inner non-porous region and for the outer porous region of the sleeve comprises titanium.

14. The implant of either of claims 11 or 12, wherein the outer porous region of the sleeve has a defined porosity of 60 to 80% by volume and a mean pore diameter of 100 to 2000 mm.

15. The implant of either of claims 11 or 12, wherein the inner non-porous region has a thickness of at least 2 mm, particularly of at least 3 mm.

16. The method of claim 4 wherein the metal powder has an average particle size les than 45 mm.
